(19) United States
(12) Patent Application Publication
(10) Pub. No.: US 2006/0294178 A1
(43) Pub. Date: Dec. 28, 2006

(54) Carry-ripple adder

(76) Inventors: Marc Bernhardt, Achenheim (FR); Joel Hatsch, Unterhaching (DE); Winfried Kamp, Munchen (DE); Siegmar Koeppe, Munchen (DE)

Correspondence Address: BRINKS HOFER GILSON & LIONE;INFINEON, PO BOX 10395, CHICAGO, IL, 60610, US

(21) Appl. No.: 11/203,445

(22) Filed: Aug. 12, 2005

Related U.S. Application Data
(63) Continuation of application No. PCT/DE04/00796, filed on Jan. 29, 2004.

(30) Foreign Application Priority Data
Feb. 12, 2003 (DE) 103 05 849.4
Feb. 12, 2003 (DE) DE 103 05 579.4

(51) Int. Cl. G06F 7/50

(52) U.S. Cl. 708/707

(57) ABSTRACT

A carry-ripple adder having inputs for supplying three input bits of equal significance 2ⁿ that are to be summed and two carry bits of equal significance 2ⁿ⁺¹ that are also to be summed. A calculated sum bit of significance 2ⁿ and two calculated carry bits of equal significance 2ⁿ⁺¹ which are higher than the significance 2ⁿ of the sum bit are provided at outputs. A final carry-ripple stage VMA may be used even after a reduction to three bits.

### PRIORITY AND CROSS REFERENCE TO RELATED APPLICATION

This application is a continuation of International Application No. PCT/DE2004/000796 filed Jan. 29, 2004, which claims priority to German application 103 05 849.4 filed Feb. 12, 2003, both of which are incorporated herein in their entirety by reference.

### BACKGROUND

1. Field of the Invention

The present invention relates to the field of logic devices, and more particularly, it relates to 3 & 2 to 3 carry-ripple adders.

2. Description of the Related Art

Carry-ripple adders have sequential carry logic, and similar carry-save adders, they have a plurality of inputs of equal significance and, during operation, sum the bits applied to these inputs. The sum is provided at outputs of different significance, for example in binary coded numerical notation (BCD).

In order to add a plurality of bits of equal significance, for example in multipliers, it is known to build carry save adder arrays, for example in accordance with the Wallace tree algorithm, and to finally use a vector merging adder (VMA) to convert the resultant sum, and carry data representation in redundant numerical notation into unambiguous numerical notation. This final stage is often in the form of a carry-ripple adder, two bits of equal significance respectively being summed. In the case of such an approach, it is thus necessary for the carry save adder tree to generally be reduced to two bits for the purposes of addition.

Consequently, use has only been made of carry-nipple adders that add two input bits and one carry, one sum bit of significance 2ⁿ and one carry of significance 2ⁿ⁺¹ being generated. This results in the need for multistage approaches such that a carry save adder tree in accordance with the number of input bits is first of all used and finally a 2-bit carry-ripple adder is used.

Solutions for carry-ripple adders that add up to five input bits of equal significance, for example 2ⁿ, are known. However, these configurations are disadvantageous, both as regards the processing speed and as regards the substrate area required, for an implementation using complementary CMOS gates on account of the resultant high number of transistors.

### BRIEF SUMMARY OF THE INVENTION

By way of introduction only, a carry-ripple adders described, including uses thereof. An exemplary carry-ripple adder enables small layouts, or reduction in the area for the carry-ripple adder, and a reduced power loss during operation. A carry-ripple adder may generate two carries, or carry bits, of equal significance, where the carries, or carry bits, are passed directly to the next stage of a multistage carry-ripple adder and assessed therein.

An exemplary carry-ripple adder may have three first inputs for supplying three input bits of equal significance 2ⁿ that are to be summed, two second inputs for supplying two carry bits of equal significance 2ⁿ⁺¹ that are also to be summed, one output for outputting a calculated sum bit of significance 2ⁿ, and two outputs for outputting two calculated carry bits of equal significance 2ⁿ⁺¹ which is higher than the significance 2ⁿ of the sum bit. A final carry-ripple stage VMA (vector merging adder) may be used even after a reduction to three bits. This makes it possible to save on one carry save stage, which has an advantageous effect on the processing speed and the substrate area of the overall circuit, or to use the third input bit of each carry-ripple adder for the efficient implementation of accumulators, for example in MAC structures.

Dynamic implementation of carry paths and their logic implementation within a carry-ripple adder additionally make it possible to optimize the area and speed in comparison with complementary or differential CMOS solutions. Simultaneously generating two carries, or carry bits, of equal significance that are assessed in each stage of the carry-ripple adder means that the circuit complexity and the internal wiring complexity are lower than multistage complementary CMOS solutions which are, for example, composed of 3-bit carry save adders and 2-bit carry-ripple adders. This also applies to dynamic carry-ripple adders having three inputs.

Because of the considerably reduced number of transistors in a carry path, the carry-ripple adder has been optimized in terms of area and power loss. The carry-ripple adder may be used as a final adder in multipliers, adder trees, filter structures, accumulators and arithmetic logic units.

An carry-ripple adder may also include a precharge input that drives an integrated precharge logic stage, a carry stage, and a summation stage, and combinations thereof. The carry stage may have two carry addition blocks that independently calculate the carry output signals in a temporally parallel manner. The summation stage may have a quintuple XOR function or block.

A bit addition device may include a parallel circuit that has multiple carry-ripple adders where 3 input bits of equal significance 2ⁿ being provided for each carry-ripple adder.

The foregoing summary is provided only by way of introduction. The features and advantages of the carry-ripple adder may be realized and obtained by means of the instrumentalities and combinations particularly pointed out in the claims. Nothing in this section should be taken as a limitation on the claims, which define the scope of the invention. Additional features and advantages of the present invention will be set forth in the description that follows, and in part will be obvious from the description, or may be learned by practice of the present invention.

### BRIEF DESCRIPTION OF THE DRAWINGS

FIG. 1 is a shows a schematic illustration of a 3 & 2 to 3 carry-ripple adder.

FIG. 2 shows a truth table for a 3 & 2 to 3 carry-ripple adder.

FIG. 3 shows a schematic illustration of an internal design of a 3 & 2 to 3 carry-ripple adder.

FIGS. 4, 4A, and 4B show a schematic illustration of the connection of a carry-ripple adder for three input words having five bits each.

FIG. 5 shows a schematic illustration of a carry stage.

FIG. 6 shows a schematic circuit diagram of a block of the carry stage shown in FIG. 5.

FIG. 7 shows a schematic circuit diagram of the second block of the carry stage shown in FIG. 5.

FIG. 8 shows a schematic illustration of a sum block.

FIG. 9 shows a schematic circuit diagram of a quintuple XOR stage of the sum block.

FIG. 10 shows a schematic block diagram for carry-ripple adders.

### DETAILED DESCRIPTION OF THE INVENTION

Exemplary carry-ripple adders will now be described more fully with reference to the accompanying drawings. In each of the following figures, components, features and integral parts that correspond to one another each have the same reference number. The drawings of the figures are not true to scale.

FIG. 1 shows a schematic illustration of a 3 & 2 to 3 carry-ripple adder 10 having three bit inputs i0, i1 and i2, two equivalent carry inputs ci1, ci2, two equivalent carry outputs co1, co2 and a sum output s.

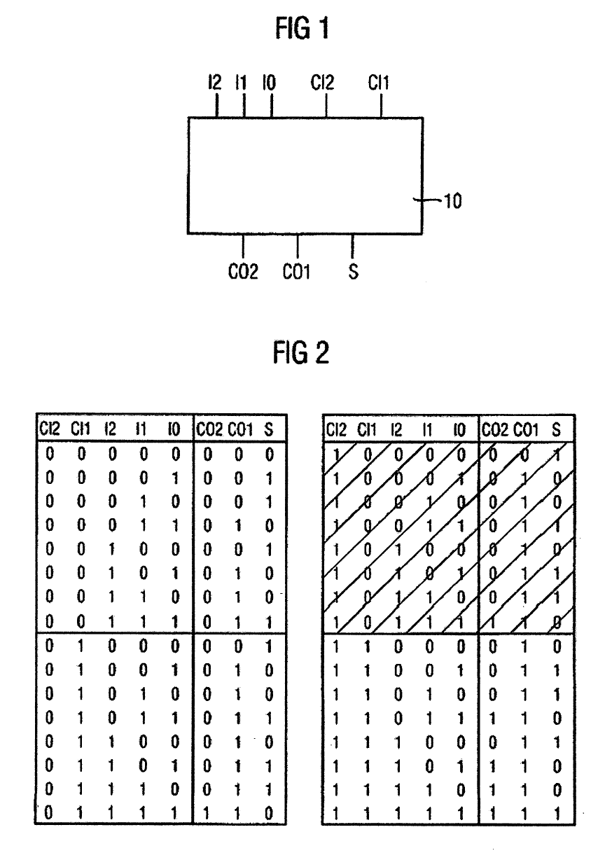

FIG. 2 shows a truth, or function, table for one bit in the carry-ripple adder shown in FIG. 1. On the basis of the coding selected for the two equivalent carry output signals co2 and co1, input combinations where ci2=1 and ci1=0 (hashed in FIG. 2) do not occur during operation since ci2 can only be set if ci1 has also been set, from which a double carry is deduced. This fact that “don't care elements” occur is used to minimize the circuit. The simple sum of the five input bits at the inputs i0, i1, i2, ci1, ci2 results at position s in the table, and a carry is generated at the output co1 if the sum of the input bits is, for example,≧2, a 1 being applied to the output co2 as soon as the sum of the five input bits is ≧4 but co1 then already having been set to 1 since the sum is also ≧2.

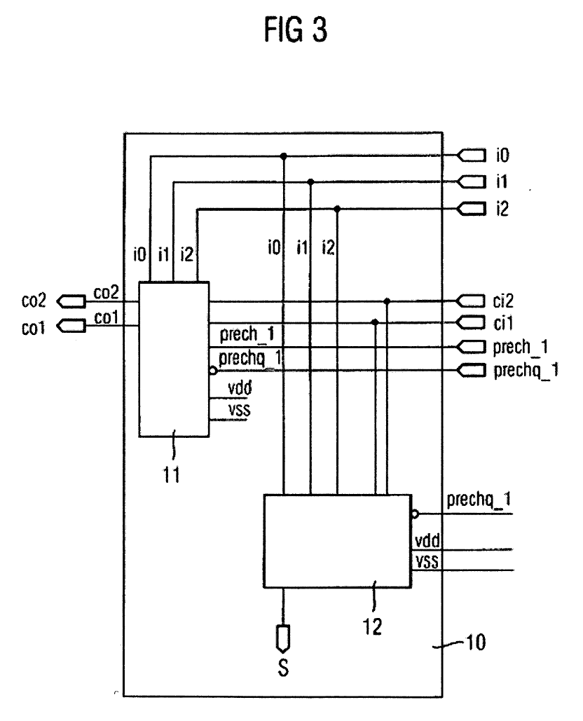

FIG. 3 shows a block diagram of an exemplary basic design of a carry-ripple adder 10 having three input bits i0, i1, i2, two equivalent carry inputs ci1, ci2, two equivalent carry outputs co1, co2 and a sum output s. The adder 10 includes two blocks 11, 12: a carry stage 11, and a summation stage or circuit 12. The signals prech_1 and prechq_1 which are optionally supplied preferably control an integrated precharge logic stage if a dynamic implementation is provided. The three input bits i0, i1, i2 and the two carry input bits ci1 and ci2 are respectively supplied to the two blocks 11 and 12, as are a supply voltage vdd and a reference ground potential vss. The carry outputs co1 and co2 are operated using the carry block 11. In the a dynamic implementation, the precharge signals prech_1 and prechq_1 are applied to complementary inputs of the carry block 11. The summation block 12 has the sum output s, and the precharge signal prechq_1 is applied to an inverting input of said summation block in the case of a dynamic implementation.

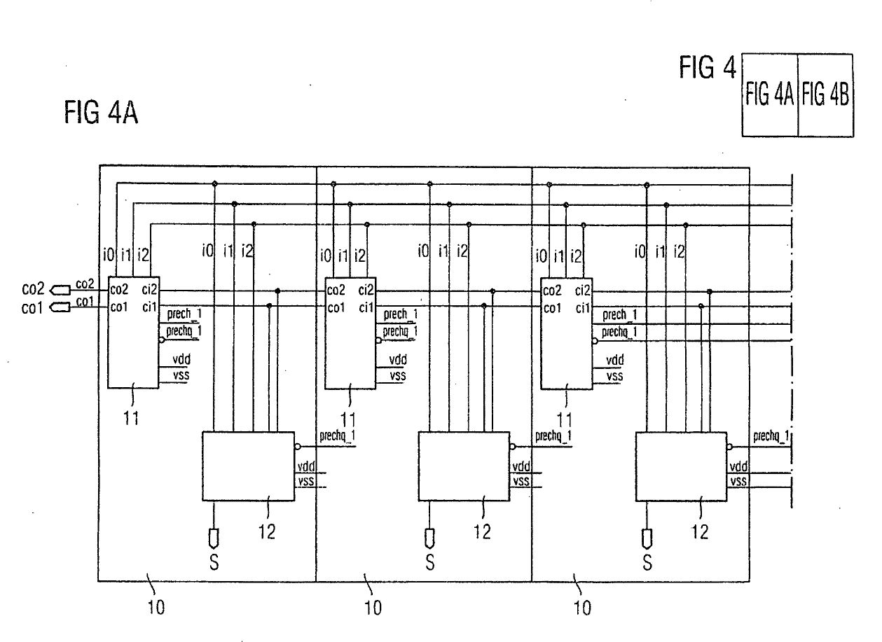

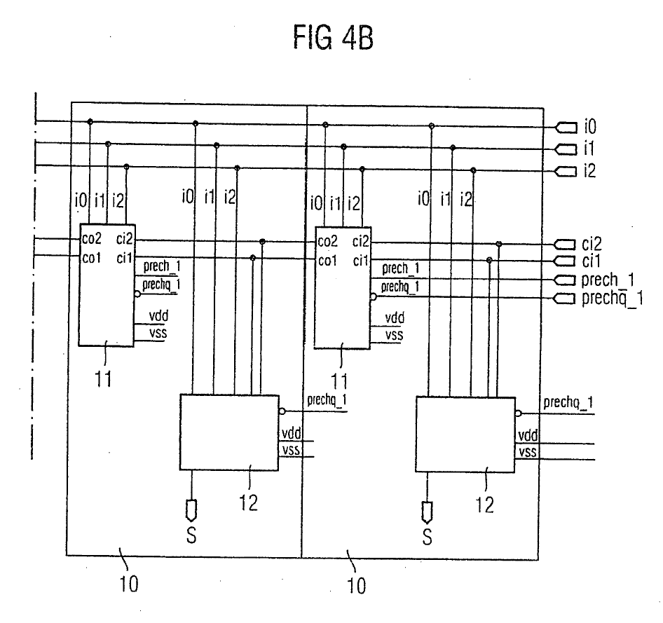

FIGS. 4, 4A, and 4B schematically show the connection of a carry-ripple adder for three input words i0, i1 and i2 each having 5 bits <4:0>, 5 carry-ripple adders as shown in FIG. 2 being coupled to one another, one carry-ripple adder 10 for each bit position <n> (n=0 to 4). The nth stage adds to the three input bits i0<n>, i1<n> and i2<n> having the significance 2ⁿ two carry input signals ci1<n> and ci2<n> which likewise have the significance 2ⁿ and generates a sum signal s_n of equal significance 2ⁿ and two carry output signals co1<n+1>, co2<n+1> of the next higher significance 2ⁿ⁺¹ which correspond to the carry input signals ci1<n+1>, ci2<n+1> of the n+1th stage, n being an integer between 0 and 4, inclusive, in the present example shown in FIG. 4.

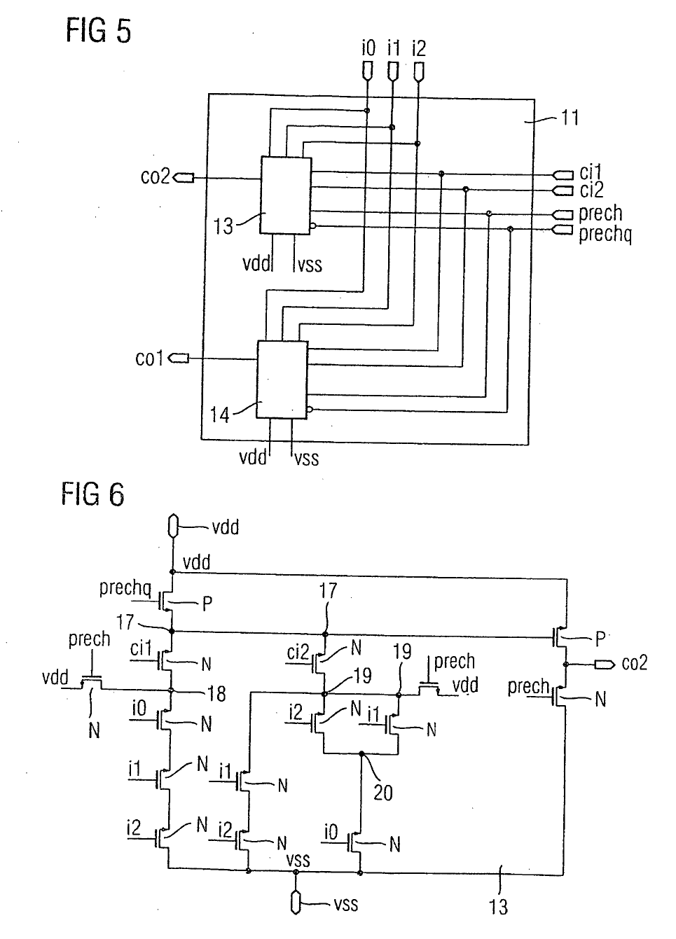

FIG. 5 schematically shows a carry stage 11 of a carry-ripple adder as shown in FIG. 3 and/or FIG. 4. The carry stage 11 has two blocks 13 and 14 which each calculate a carry output signal co2 and co1 independently of one another and thus in a temporally parallel manner. Both the block 13 for calculating the carry output signal co2 and the block 14 for calculating the carry output signal co1 are connected to the inputs i0, i1, i2, ci1 and ci2 of the supply voltage vdd and the reference ground potential vss. In the case of a dynamic implementation, the two blocks 13 and 14 are preferably connected to the precharge signals prech and prechq that are supplied in such a manner that they are inverted, or having opposite poloarity, with respect to one another.

FIG. 6 shows a schematic circuit diagram of a dynamic implementation of the block 13 (shown in FIG. 5) for generating the carry output signal co2 on the basis of the signals at the three bit inputs i0, i1, i2, the two carry inputs ci1 and ci2 and the precharge signals prech and prechq. A p-channel field effect transistor P is driven, on the gate side, by the precharge signal prechq. The p-channel field effect transistor P is also connected between the supply voltage vdd and a node 17. An n-channel FET N is connected, on the gate side, to the carry input ci1. The n-channel FET N is also connected between the node 17 and a node 18. The node 18 may be connected to the supply voltage vdd via an n-channel FET N that is driven, on the gate side, with the precharge signal prech. A series circuit comprising three n-channel FETs N is located between the node 18 and the reference ground potential vss, one of said n-channel FETs being connected, on the gate side, to i0, the next n-channel FET being connected, on the gate side, to i1, and the third n-channel FET being connected, on the gate side, to i2.

An n-channel FET is connected, on the gate side, to the carry input ci2, and is connected between the node 17 and a node 19. A series circuit comprising two n-channel FETs N is located between the node 19 and the reference ground potential vss, one of said n-channel FETs in the series circuit of two n-channel FETs between node 19 and the reference ground is connected, on the gate side, to i1 and the other is connected to i2. A parallel circuit of two n-channel FETs N is parallel to said series circuit between the node 19 and a node 20. One of the n-channel FETs of the parallel cirucit of two n-channel FETs N between node 19 and 20 is connected, on the gate side, to i1, the second is connected, on the gate side, to i2. The drains of each of the n-channel FETs of the parallel cirucit are combined or connected to node 20 which is connected to the reference ground potential vss via an n-channel FET N to which i0 is applied on the gate side. The node 19 is optionally connected to the supply voltage vdd via an n-channel FET having a gate connected to the precharge signal prech.

A series circuit of a p-channel FET P and an n-channel FET N is arranged in a further parallel branch between the supply voltage vdd and the reference ground potential vss, where the p-channel FET P is connected, on the gate side, to node 17 and the precharge signal prech is applied to the n-channel FET N on the gate side. The carry output co2 is provided at a junction between the p-channel field effect transistor P and the n-channel FET N of the series circuit between the supply voltage vdd and the reference ground potential vss.

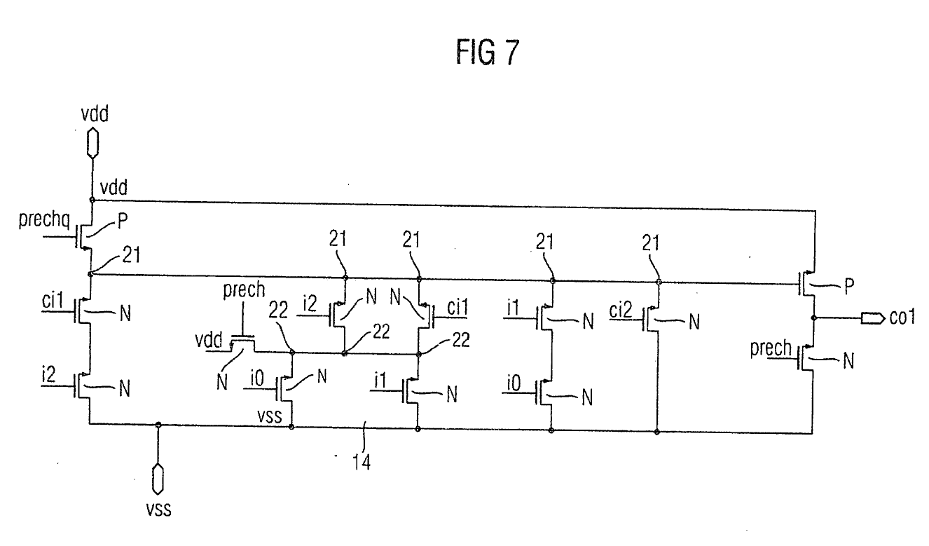

FIG. 7 illustrates a schematic circuit for dynamically implementing the block 14 shown in FIG. 5. A p-channel FET P having a gate to which the precharge signal prechq is applied, is connected between a supply voltage vdd and a circuit node 21. A series circuit of two n-channel FETs N is provided between the node 21 and a reference ground potential vss. The carry input ci1 is applied to the gate of one of the n-channel FETs and i2 is applied to the gate of the second n-channel FET of the series circuit of two n-channel FETs N provided between the node 21 and the reference ground potential. A parallel circuit of two n-channel FETs N is parallel to the series circuit between the node 21 and a node 22, where one of the n-channel FETs is connected, on the gate side, to i2 and the other n-channel FETs is connected, on the gate side, to the carry input ci1. The node 22 is connected in turn, via a parallel circuit of two n-channel FETs N, to the reference ground potential vss in a manner dependent on i0 or i1. One of the n-channel FETs of the parallel circuit between node 22 and the reference ground Vss is connected, on the gate side, to i0 and the other n-channel FETs is connected, on the gate side, to i1.

The circuit node 22 may be connected, via an n-channel FET N, to the supply voltage vdd in a manner dependent on the precharge signal prech, where the precharge signal prech is connected to the gate of the n-channel FET N connected between the supply voltage and node 22.

Provided as further parallel branches between the circuit node 21 and the reference ground potential vss is a series circuit of two n-channel FETs N, where i1 is applied to one of the n-channel FETs on the gate side, and i0 is applied to the other n-channel FET on the gate side. In addition, an n-channel FET N to which ci2 is applied on the gate side, is connected parallel to the series circuit between the circuit node 21 and the reference ground potential vss. A series circuit of a p-channel FET P and an n-channel FET N is connected, as a parallel branch, between the supply voltage vdd and the reference ground potential vss. The p-channel FET P of the series circuit connected between the supply voltage vdd and the reference ground potential vss is connected, on the gate side, to the node 21. The n-channel FET N of the series circuit connected between the supply voltage vdd and the reference ground potential vss is connected, on the gate side, to receive the precharge signal prech. The carry output signal co1 is provided at the junction of the p-channel FET P and n-channel FET N of the series circuit connected between the supply voltage vdd and the reference ground potential vss.

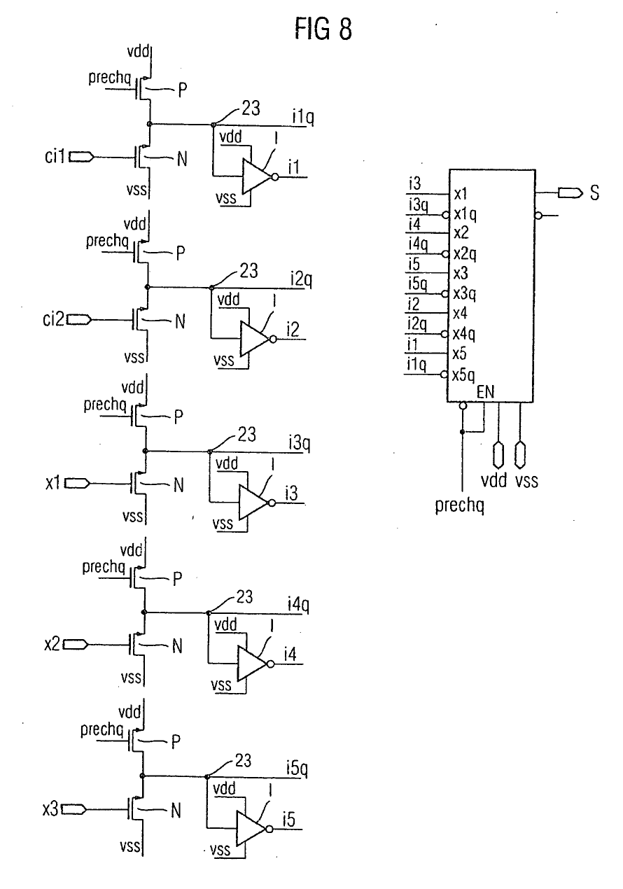

FIG. 8 shows a schematic illustration of the sum block 12 shown in FIG. 3 and/or FIG. 4 and shows (on the left hand part) a possible implementation of the input stage. A series circuit comprising a p-channel FET P and an n-channel FET N is arranged between a supply voltage vdd and a reference ground potential vss, where the precharge signal prechq is applied to the p-channel field effect transistor P on the gate side, and the signal at the carry input ci1 is applied to the n-channel FET N on the gate side. The circuit node 23 at which the signal i1q is tapped off is located between the p-channel FET P and the n-channel FET N. The signal i1q at the node 23 is converted into a signal i1 using an inverter 1 which is connected to both the reference ground potential vss and the supply voltage vdd. A similar input stage is provided for each input signal ci1, ci2, x1 (which corresponds to i0), x2 (which corresponds to i1) and x3 (which corresponds to i2) (see FIG. 4). The signals i2q and i2 are generated, for the sum block, from the carry input ci2. The signals i3 and i3q are generated from the input signal x1. The signals i4 and i4q are generated from the input signal x2. The signals i5 and i5q are generated from the input signal x3.

FIG. 8 shows (on the right hand part) a schematic illustration of the sum block, with resorting likewise being carried out again in this case since i3 shown in FIG. 8 (left-hand part) becomes x1, i3q becomes x1q, i4 becomes x2, i4q becomes x2q, i5 becomes x3, i5q becomes x3q, i2 becomes x4, i2q becomes x4q, i1 becomes x5 and i1q becomes x5q. In addition, the summation device shown in FIG. 8 (right hand part) has a precharge access having the signal prechq, an enable input EN (the signal prechq also being applied to the enable input EN), a sum output s and a connection to the reference ground potential vss and the supply voltage vdd. The input stage shown in FIG. 8 (left hand part) is used to synchronize the sum stage with dynamic circuit parts of the overall circuit.

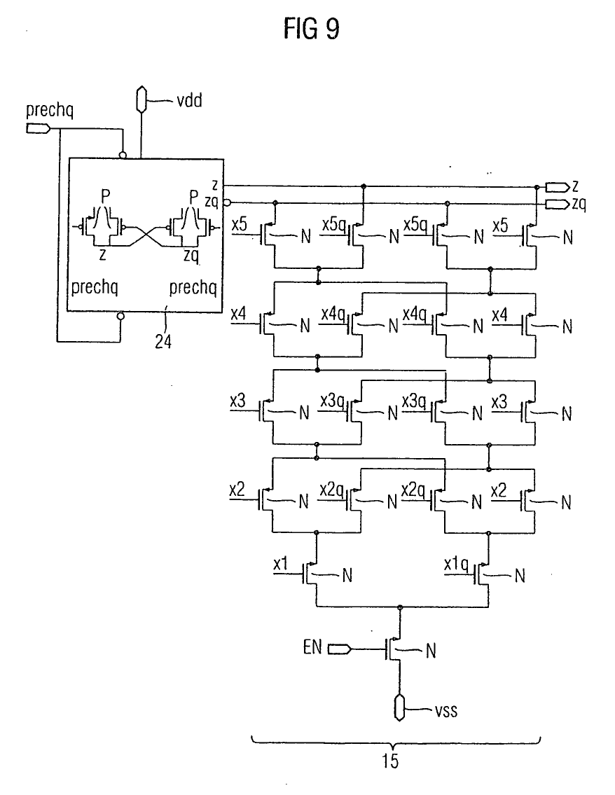

FIG. 9 shows a schematic circuit diagram, of an exemplary quintuple XOR function stage, or circuit, as the sum block shown in FIG. 8. The two time critical carry signals ci1, which are converted into i1 and i1q, and thus into x5 and x5q (see FIG. 8), and the carry input signal ci2, which is converted into i2 and i2q, and thus into x4 and x4q, are preferably connected to n-channel field effect transistors N located next to the outputs Z and ZQ of the XOR circuit. The quintuple XOR stage 15 shown in FIG. 9 is connected to the supply voltage vdd by means of an upstream connection 24 in a manner dependent on the precharge signal prechq and, in addition, can be connected to the reference ground potential vss via an enable signal EN at the gate of an n-channel field effect transistor N. This enable signal EN is supplied via the enable input shown in FIG. 8 (right hand part).

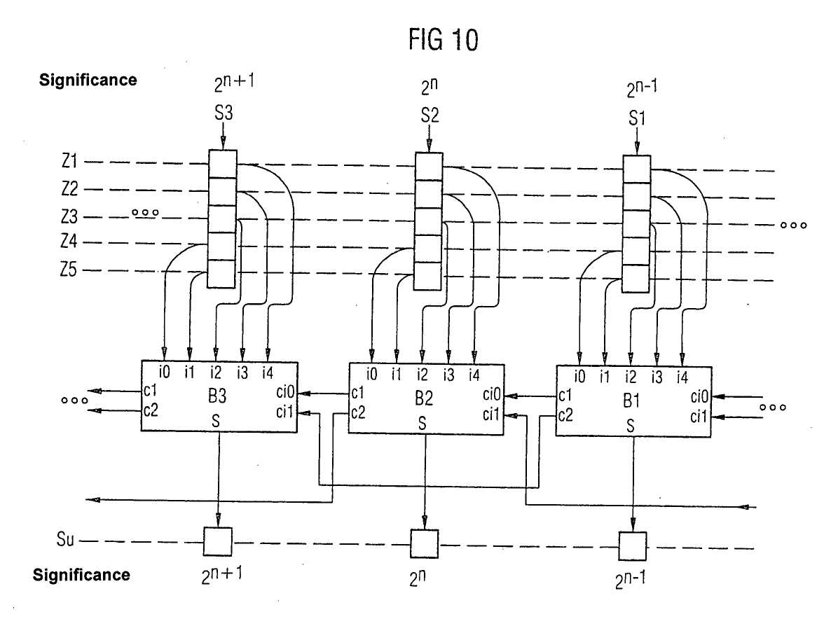

FIG. 10 illustrates carry-ripple adders B1, B2, B3 where the output carry bits are of unequal significance.

Although the present invention has been described above with reference to a preferred exemplary embodiment, it is not restricted thereto but rather can be modified multifariously. The circuit principle of the carry path, which is based on calculating and forwarding two carries of equal significance, can therefore also be used for two carry signals which are interchangeable. In addition, the blocks which are used to generate the two carry signals are not necessarily independent of one another. In the case of an implementation using complementary CMOS gates, it is possible to make joint use of subblocks. However, separation is advantageous for a high-performance application.

In addition, the n-channel transistors N which are located in the evaluation part of the carry gates (see FIG. 6 and FIG. 7) and to whose gate the precharge signal prech is applied are not required for a basic implementation of the logic function. They reduce the charge sharing problem that can arise depending on the technology and layout. They are therefore optional, may also be in the form of p-channel FETs with inverted driving, and constitute advantageous optimization. Any static or dynamic quintuple XOR gate may, in principle, be used as the sum stage. In addition, other carry-ripple adder may be utilized without any restriction.

The above described embodiments are given as illustrative examples only. It will be readily appreciated that many deviations may be made from the embodiments disclosed in this specification without departing from the invention. Accordingly, the invention is not to be restricted except in light of the attached claims and their equivalents.

### LIST OF REFERENCE SYMBOLS

i0, i1, i2 Inputs for input bits
x1, x2, x3 Inputs for input bits
i0<0> i0<4>,
i1<0> i1<4>,
i2<0> i2<4> Input bits at corresponding inputs
ci1, ci2 Inputs for carry bits
s, s0 s4 Summation outputs
cot, cot Outputs for carry bits
2n Significance of a bit (n=natural number)
2n+1 Significance of a bit that has been increased by one
prech, prechq Precharge inputs
prech 1, prechq 1 Precharge inputs
vdd Supply voltage
vss Reference ground potential
10 Carry-ripple adder/bit summation device
11 Carry stage (carry summation)
12 Summation stage (normal summation or carry)
13 Carry addition block
14 Carry addition block
15 Quintuple XOR stage
16 Multibit carry-ripple adder
17, 18, 19, 20 Circuit nodes
21, 22, 23 Circuit nodes
24 Upstream connection of the quintuple XOR stage
B1, B2, B2 Carry-ripple adders based on the prior art in which the output carry bits are of unequal significance
P, N p-channel FET, n-channel FET
en Enable signal

What is claimed is:

1. A carry-ripple adder comprising:
three first inputs (i₀, i₁, i₂) for supplying three input bits (i₀<n>, i₁<n>, i₂<n>) of equal significance 2ⁿ that are to be summed;
two second inputs (ci₁, ci₂) for supplying two carry bits (ci₁<n>, ci₂<n>) of equal significance 2ⁿ that are likewise to be summed;
one output configured to provide a calculated sum bit (s_n) of the same significance 2ⁿ; and
two outputs (co₁, co₂) configured to provide two calculated carry bits (co₁<n+1>, co₂<n+1>) of equal significance 2ⁿ⁺¹ which is higher than the significance 2ⁿ of the sum bit (s_n).

2. The carry-ripple adder as in claim 1, where the carry-ripple adder is configured as a final adder for any one of a multiplier, adder tree, accumulator, filter structure, arithmetic logic unit, and combinations thereof.

3. The carry-ripple adder of claim 1, further comprising a carry stage and a summation stage.

4. The carry-ripple adder of claim 3, where the summation stage comprises a quintuple XOR block.

5. The carry-ripple adder of claim 4, further comprising two carry addition blocks configured to calculate the carry output signals (co1<n+1>, co2<n+1>) independently of one another and in a temporally parallel manner.

6. The carry-ripple adder of claim 5, where at least one carry addition block comprises:
an n-channel FET being connected between a first node and a second node and on the gate side, to receive the carry input (ci₂);
a series circuit of two n-channel FETs being between the second node and a reference ground potential, a first n-channel FETs of the series circuit being connected, on the gate side, to receive (i₁) and the second n-channel FET being connected to receive (i₂); and
a parallel circuit having two n-channel FETs being parallel to the series circuit between the second node and a third node, one of the n-channel FETs of the parallel circuit being connected, on the gate side, to receive (i₁), the second n-channel FET being connected, on the gate side, to receive (i₂), the drains of the n-channel FETs of the parallel circuit being combined in at third node, the third node being coupled to the reference ground potential via an n-channel FET to which (i₀) can be applied on the gate side.

7. The carry-ripple adder of claim 6, where at least one carry addition block has an n-channel FET (N)—which is connected, on the gate side, to the carry input (ci₂)—between a node (21) and the reference ground potential, where a supply voltage is configured to be applied to the node (21) via a p-channel FET (P) that is connected, on the gate side, to a precharge input (prechq).

8. The carry-ripple adder of claim 1, further comprising at least one precharge input (prech, prechq) configured to drive an integrated precharge logic stage.

9. The carry-ripple adder of claim 8, further comprising a carry stage and a summation stage.

10. The carry-ripple adder of claim 9, where the summation stage has a quintuple XOR block.

11. The carry-ripple adder of claim 9,further comprising two carry addition blocks configured to calculate the carry output signals (co1<n+1>, co2<n+1>) independently of one another and in a temporally parallel manner.

12. The carry-ripple adder of claim 11, where at least one carry addition block comprises:
an n-channel FET being connected between a first node and a second node and on the gate side, to receive the carry input (ci₂);
a series circuit of two n-channel FETs being between the second node and a reference ground potential, a first n-channel FETs of the series circuit being connected, on the gate side, to receive (i₁) and the second n-channel FET being connected to receive (i₂); and
a parallel circuit having two n-channel FETs being parallel to the series circuit between the second node and a third node, one of the n-channel FETs of the parallel circuit being connected, on the gate side, to receive (i₁), the second n-channel FET being connected, on the gate side, to receive (i₂), the drains of the n-channel FETs of the parallel circuit being combined in at third node, the third node being coupled to the reference ground potential via an n-channel FET to which (i₀) can be applied on the gate side.

13. The carry-ripple adder of claim 12, where at least one carry addition block has an n-channel FET (N)—which is connected, on the gate side, to the carry input (ci₂)—between a node (21) and the reference ground potential, where a supply voltage is applied to the node (21) via a p-channel FET (P) that is connected, on the gate side, to a precharge input (prechq).

14. The carry-ripple adder as in claim 13, where the carry-ripple adder is configured as a final adder for any one of a multiplier, adder tree, accumulator, filter structure, arithmetic logic unit, and combinations thereof.

15. A bit addition device comprising:
a parallel circuit including a plurality of carry-ripple adders, each carry-ripple adder having:
at least three first inputs (i₀, i₁, i₂) for supplying three input bits (i₀<n>, i₁<n>, i₂<n>) of equal significance 2ⁿ that are to be summed;
at least two second inputs (ci₁, ci₂) for supplying two carry bits (ci₁<n>, ci₂<n>) of equal significance 2ⁿ that are to be summed;
an output configured to provide a calculated sum bit (s_n) of the same significance 2ⁿ; and
at least two outputs (co₁, co₂) configured to provide two calculated carry bits (co₁<n+1>, co₂<n+1>) of equal significance 2ⁿ⁺¹ which is higher than the significance 2ⁿ of the sum bit (s_n), where 3 input words (i₀<n>, i₁<n>, i₂<n>) of equal significance 2ⁿ are provided to each carry-ripple adder.

16. A carry-ripple adder comprising:
a first input configured to receive input bits of equal significance 2ⁿ which are to be summed;
a second input configured to receive carry bits of equal significance 2ⁿ which are likewise to be summed;
an output configured to provide a calculated sum bit of the same significance 2ⁿ; and
a carry output configured to provide two calculated carry bits of equal significance 2ⁿ⁺¹ which is higher than the significance 2ⁿ of the sum bit.

17. The carry-ripple adder as in claim 16, where the carry-ripple adder is configured as a final adder for any one of a multiplier, adder tree, accumulator, filter structure, arithmetic logic unit, and combinations thereof.

18. The carry-ripple adder or claim 16, further comprising a carry stage and a summation stage.

19. The carry-ripple adder of claim 18, where the summation stage comprises a quintuple XOR block.

20. The carry-ripple adder of claim 18, further comprising two carry addition blocks configured to calculate the carry output signals independently of one another and in a temporally parallel manner.

21. The carry-ripple adder of claim 16, further comprising at least one precharge input configured to drive an integrated precharge logic stage.
